(19) United States
(12) Patent Application Publication
(10) Pub. No.: US 2025/0018591 A1
(43) Pub. Date: Jan. 16, 2025

(54) APPARATUS AND METHOD FOR MAKING WINDOW CUTOUTS IN A FRAME MATERIAL IN WEB FORM

(71) Applicant: OPTIMA life science GmbH, Schwäbisch Hall (DE)

(72) Inventors: Johannes Jansen, Michelfeld (DE); Martin Dennert, Brey (DE)

(73) Assignee: OPTIMA life science GmbH, Schwäbisch Hall (DE)

(21) Appl. No.: 18/770,728

(22) Filed: Jul. 12, 2024

(30) Foreign Application Priority Data
Jul. 12, 2023 (DE) 102023118404.0

(51) Int. Cl. B26F 1/10; C25B 9/23; H01M 8/1004

(52) U.S. Cl. CPC B26F 1/10; C25B 9/23; H01M 8/1004

(57) ABSTRACT

The invention relates to an apparatus and a method for making window cutouts (22) in a frame material (20) in web form for a membrane electrode unit, wherein, at least in some section or sections, the frame material (20) is processed as a material combination with a carrier web (30), wherein a contour cut (50) that cuts through the frame material (20) is made in the frame material (20) from an opposite side of the frame material (20) to the carrier web (30), while forming a punching chad (201), wherein the contour cut (50) is made without cutting through the carrier web (30), wherein the punching chad (201) is separated from the material combination using a rotatable roller (40, 40a) having a suction opening (402), wherein a suction force is applied to the punching chad (201) via the suction opening (402), with the result that the punching chad (201) is detached from the carrier web (30) by use of the suction force and transported away from the material combination using the roller (40, 40a). The invention furthermore relates to the use of a rotatable roller in making window cutouts.

### CROSS-REFERENCE TO RELATED APPLICATION

The present application claims priority to German Patent Application No. 102023118404.0, filed Jul. 12, 2023, the entirety of which is incorporated herein by reference.

### TECHNICAL FIELD AND PRIOR ART

The invention relates to an apparatus and a method for making window cutouts in a frame material in web form for a membrane electrode unit. The invention furthermore relates to the use of a rotatable roller in making window cutouts.

Production of a membrane electrode assembly (MEA for short) or parts thereof for a fuel cell, an electrolysis cell or a redox flow cell (liquid battery) or membrane-based air humidifiers from webs of material is known. In some embodiments, the MEA comprises a catalyst-coated membrane (CCM for short), on one or both sides of which rim reinforcements or frames of less expensive and more robust material are provided. For an additional structure on top, two gas diffusion layers (GDL for short) can be applied to outer sides of the MEA. Here, application of the GDL can take place in the same process as the production of the MEA comprising the CCM and the frame or frames or can take place in a process at a different location and/or different time. In another embodiment, an MEA comprising a membrane and two gas diffusion layers arranged thereon is prepared, wherein rim reinforcements or frames are applied to one or both sides of this MEA.

In this context, there is a known practice of preparing a frame material in web form for the frames, wherein window cutouts are made in the frame material, and the CCM is connected in such a way to the frame material that an active region is arranged in the window cutouts and a rim of the active region is covered by the frames. The window cutouts are made by punching, in particular rotary punching, for example. A region of the frame material that is situated within the window cutouts and is to be removed is therefore also referred to as a punching chad.

Also known is the provision on the frame material of an adhesive coating for connection to the CCM, wherein the adhesive layer is covered with a protective film. In some embodiments, the protective film also serves for stabilization of the frame material and, in known apparatuses and methods, is delaminated from the frame material after the punching process. In the context of the application, delamination is used to denote pulling off or detachment. In order to ensure sufficient stability of the frame material for further processing after delamination of the protective film, there is a known practice of applying the frame material to a counter-element before the delamination of the protective film. The counter-element is, for example, a carrier web, which is laminated to the frame material.

In this context, DE102021209815 A1, for example, discloses the practice of leaving the punching chads on the carrier web to protect the CCM.

As an alternative, the punching chads are to be removed from the frame material in a single step with the delamination of the protective film. During delamination of the protective film after lamination of the frame material with a carrier web, an adhesive effect of the protective film on the punching chads must overcome both an adhesive effect of the carrier web on the punching chads and an inherent stiffness of the punching chads as they are deflected away from the frame material. At the same time, an adhesive effect of the carrier web on the frame material must be sufficient to ensure that no regions of the frame material that are weakened by the window cutouts are pulled off or raised from the carrier web and subsequently lead to creasing or air inclusions in the MEA.

### OBJECT AND SOLUTION

It is the object of the invention to provide an apparatus and a method for making window cutouts in a frame material in web form for a membrane electrode unit which allow reliable detachment and removal of punching chads.

These objects are solved by the subject matter having the features of claims 1, 9 and 13. Advantageous embodiments will be found in the dependent claims.

According to a first aspect, an apparatus for making window cutouts in a frame material in web form for a membrane electrode unit is provided, wherein a punching device and a detachment device are provided, wherein the frame material can be fed to the punching device as a material combination with a carrier web, wherein the punching device is configured to make in the frame material a contour cut that cuts through the frame material from a side of the frame material opposite to the carrier web, while forming a punching chad, without cutting through the carrier web, wherein the detachment device is configured to separate the punching chad from the material combination, wherein the detachment device comprises a rotatable roller and a vacuum device, wherein a suction opening that can be connected fluidically to the vacuum device is provided on the roller, and wherein the vacuum device is configured to apply a suction force to the punching chad via the suction opening as the roller rotates in order to detach the punching chad from the carrier web by use of the suction force and to transport it away from the material combination using the roller.

According to a second aspect, a method for making window cutouts in a frame material in web form for a membrane electrode unit is provided, wherein, at least in some section or sections, the frame material is processed as a material combination with a carrier web, wherein a contour cut that cuts through the frame material is made in the frame material from a side of the frame material opposite to the carrier web, while forming a punching chad, wherein the contour cut is made without cutting through the carrier web, wherein the punching chad is separated from the material combination using a rotatable roller having a suction opening, and wherein a suction force is applied to the punching chad via the suction opening, with the result that the punching chad is detached from the carrier web and transported away from the material combination using the roller.

According to a third aspect, the use of a rotatable roller in making a window cutout in a frame material in web form for a membrane electrode unit is provided, wherein the frame material can be fed to the roller as a material combination with a carrier web, wherein a suction opening that can be connected fluidically to a vacuum device is provided on the roller, wherein, as the roller rotates, a suction force is applied via the suction opening to a punching chad of the frame material arranged in the window cutout in order to detach the punching chad from the carrier web by use of the suction force and to transport it away from the material combination using the roller.

In the context of the application, the terms “a”, “an” etc. are used as indefinite articles and not as quantifiers. In particular, in some embodiments the roller comprises more than one suction opening connected to the vacuum device. Via the suction opening or suction openings, a suction force is applied to the punching chad. The suction openings are many times smaller than a window cutout to be made, and therefore the punching chad is sucked against the roller but not sucked into the suction openings.

In some embodiments, the roller is configured as a punching and detachment roller comprising the suction opening and a closed punching contour for the contour cut to be made, wherein the suction opening is arranged within the closed punching contour. In this case, the punching chads are transported away as the frame material is cut through during the introduction of the contour cuts.

As mentioned, the term “a” or “an” should be understood merely as an indefinite article, and, in some embodiments, several punching contours are provided on the punching and roller, an detachment wherein appropriate distribution and/or spacing between the punching contours in the circumferential direction of the punching and detachment roller can be specified by a person working in this technical field, depending on various boundary conditions, such as the size of the roller, a process speed and/or a size of the frames to be produced.

In some embodiments, for better detachment of the punching chad from the carrier web, an embossing roller for applying an embossed line to the punching chad is provided upstream of the punching and detachment roller.

In some embodiments, the punching and detachment roller is configured as a vacuum roller comprising a multiplicity of suction openings arranged in a manner distributed over the circumference, wherein the apparatus comprises a punching plate, which has the punching contour and can be secured, in particular detachably, on a circumference of the punching and detachment roller, wherein the punching plate has, within the punching contour, an aperture for one or more suction openings. In some embodiments, the vacuum roller is configured as a magnetic vacuum roller, wherein the punching plate can be secured on a circumference of the magnetic vacuum roller by magnetic force. In some embodiments, the punching plates are configured in a manner suitable for covering suction openings in regions which surround the punching contour, thus ensuring that no suction force is applied to the frame material via these suction openings. Alternatively or in addition, provision is made in some embodiments for suction openings of the vacuum roller to be selectively activatable. In yet other embodiments, the suction openings are arranged in a nonuniform manner over the circumference in order to create regions with a suction effect and regions without a suction effect.

Depending on the specific use, the aperture can be configured in a suitable manner to ensure that one or more suction openings within the punching contour are exposed, thus enabling the suction force for detaching the punching chad to be applied via these suction openings. For reliable detachment, some embodiments provide an aperture or a plurality of apertures for exposing suction openings, in particular in a region adjoining a punching contour edge that is in the lead in the direction of rotation, thus ensuring that a start of the punching chad is detached.

In some embodiments, the aperture or apertures is/are delimited by a continuous or interrupted ridge projecting from a surface of the punching plate. The ridge makes it possible to delimit a region in which the suction force acts on the punching chad. In this case, the punching chad is bent within the aperture in the direction of the vacuum roller for reliable detachment. At the same time, distortion of the frame material in a frame material section situated opposite the punching contour is prevented.

The configuration of the punching and detachment roller as a vacuum roller, in particular as a magnetic vacuum roller, is distinguished by its high flexibility, wherein a number and/or arrangement of the punching plates can be specified in a suitable manner, depending on the application, and simple conversion of the apparatus in the event of a change in format is possible.

However, the invention is not limited to the use of a vacuum roller and punching plates. In particular, provision is made in some embodiments for the punching and detachment roller to comprise a rotating roller body with a closed surface, wherein the punching contour is provided on a surface of the roller body, and wherein an insert for the suction opening is provided on the surface of the roller body within the punching contour. As one embodiment, a ridge which surrounds the suction opening for the application of the suction force is provided on the insert. In some embodiments, a plurality of suction openings, via which the suction force for detaching the punching chad is applied, is provided within a region delimited by the ridge.

As an alternative to a punching and detachment roller in some embodiments, the punching device comprises a separate rotatable punching roller, wherein the punching roller has a closed punching contour for the contour cut to be made. In this case, the punching roller is arranged upstream of the roller. As mentioned, the term “a” or “an” should be understood merely as an indefinite article, and, in some embodiments, several punching contours are provided on the punching roller, wherein an appropriate distribution and/or spacing between the punching contours in the circumferential direction of the punching roller can be specified by a person working in this specialist field, depending on various boundary conditions, such as the size of the roller, a process speed and/or a size of the frames to be produced.

In some embodiments, the separate punching roller is configured in such a way that the punching chads from a protective film arranged on the frame material opposite the carrier web can be detached using the separate punching roller, wherein the roller arranged downstream of the punching roller is used to detach the punching chads of the frame material. In other embodiments, the separate punching roller serves merely to make the contour cut, while the roller is used to detach the punching chads of a protective film and the punching chads of the frame material.

In some embodiments, the punching roller has an embossing edge for the application of an embossed line on the punching chad parallel to a leading edge of the punching chad. During or before the detachment of the punching chad, a forward region of the punching chad can be bent around the embossed line. The embossed line thus serves as an aid in the detachment of the punching chad from the carrier web.

In some embodiments, it is provided that, in addition to the window cutouts, additional openings, which form channel structures or openings for connections in a subsequent material combination, are made in the frame material using the punching roller or the punching and detachment roller.

In one embodiment, it is provided that the punching contour of the punching and detachment roller or of the punching roller has an asymmetrical cutter, wherein, in particular, an angle of the cutter relative to a radial direction of the roller is larger on an inner side facing the punching chad than on an opposite outer side. On account of a wedge angle of the cutter, a cut-through material is pushed to the side during the process of cutting through. In this case, the cut-through material is pushed more strongly to the side in the case of a less steep wedge angle than in the case of an acute wedge angle. This effect is exploited by choosing a larger, i.e. less steep, angle on a side facing the punching chad than on an opposite side. The larger angle brings about detachment of the punching chad while the process of cutting through is still in progress. A smaller or more acute angle provided on the other side has the effect that the frame material adheres better to the carrier web in the region of the cutting contour.

In some embodiments, the detachment device comprises a suction funnel arranged at the circumference of the roller. In this case, a suitable configuration and/or positioning of the suction funnel can be chosen according to the application.

The use of a roller for the targeted detachment and transporting away of the punching chads of the frame material can be applied both for applications in which the frame material is made available without a protective film and for applications in which the frame material is made available on a protective film.

In one embodiment, the material can be made available as a material combination with a protective film, wherein a laminating device for applying the carrier web is configured in order to connect the carrier web to the frame material on an opposite side from the protective film, and wherein the apparatus has a delaminating device, which is arranged upstream or downstream of the punching device and the detachment device and is configured to delaminate the protective film from the frame material. If there is a separate embossing roller, it can be provided upstream or downstream of the laminating device in the direction of transport of the frame material.

In some embodiments, the protective film is delaminated after lamination of the frame material to the carrier web and before a cut is made into the frame material. This allows easy delamination of the uncut protective film and easy and correctly sorted disposal and/or recycling of the protective film and punching chads. In other embodiments, the protective film remains on the frame material as the frame material is cut into. In this case, the protective film also serves for stabilization while the frame material is being cut into. In this case, the protective film arranged on the opposite side from the carrier web is cut through together with the frame material, and punching chads of the frame material are transported away using the roller together with the punching chads of the protective film. A residual grid of the protective film remaining on the frame material after the punching chads have been transported away can then be delaminated from the frame material.

### BRIEF DESCRIPTION OF THE DRAWINGS

Further advantages and aspects of the invention will become apparent from the claims and from the description of exemplary embodiments of the invention, which are explained below with reference to the figures. The same reference signs are used for identical or similar components in the figures and the following description. In the drawings:

FIG. 1: shows production of an MEA in a web-processing process;

FIG. 2: shows a first exemplary embodiment of an apparatus for making window cutouts in a frame material;

FIG. 3a: shows a developed plan view of a segment of a vacuum roller and of a punching plate for use in an apparatus shown in FIG. 2;

FIG. 3b: shows a section along a line A-A according to FIG. 3b;

FIG. 4: shows an alternative embodiment of a punching and detachment roller for an apparatus shown in FIG. 2;

FIG. 5: shows a second exemplary embodiment of an apparatus for making window cutouts in a frame material;

FIG. 6: shows a third exemplary embodiment of an apparatus for making window cutouts in a frame material; and

FIG. 7: shows schematically a punching contour of the punching and detachment roller shown in one of FIGS. 2 to 4 or the punching roller shown in FIG. 6.

### DETAILED DESCRIPTION OF THE EXEMPLARY EMBODIMENTS

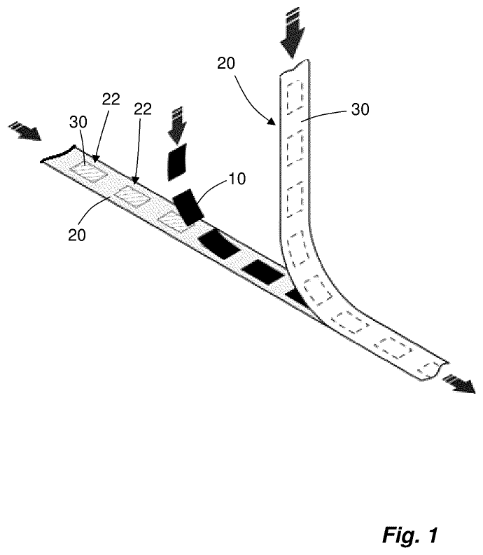

FIG. 1 shows, in a highly schematized form, a method for the production of an MEA comprising a membrane 10 fed in as a blank, e.g. a CCM, which is connected on both sides to a frame material 20 in the form of a web. The frame material 20 is in each case made available as a material combination with a carrier web 30. In other embodiments, only a frame material 20 is made available as a material combination.

Window cutouts 22 are in each case made in the frame material 20, wherein an active region of the membrane 10 is arranged in the region of the window cutouts 22.

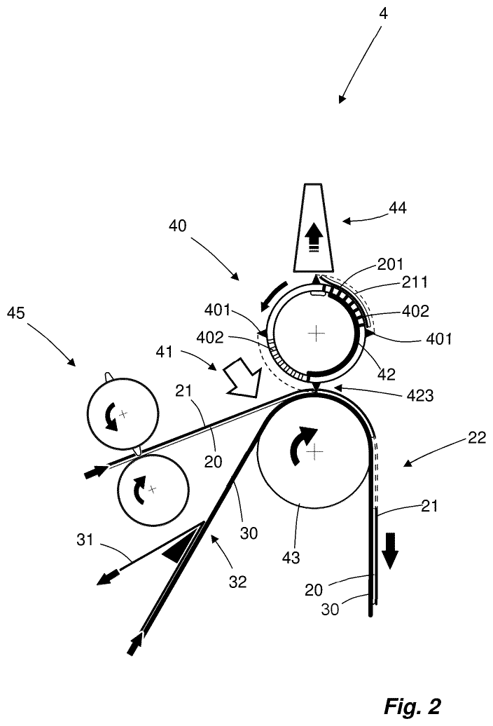

FIG. 2 shows, in a schematized form, a first exemplary embodiment of an apparatus 4 for making the window cutouts 22 in the frame material 20.

The apparatus illustrated in FIG. 2 comprises a punching and detachment roller 40. The frame material 20 is fed to the punching and detachment roller 40 as a material combination with the carrier web 30. In the exemplary embodiment illustrated, a side of the carrier web 30 which faces the frame material 20 is provided with an adhesive coating, by which the frame material 20 is laminated to the carrier web 30, that is to say in the present case releasably connected. The adhesive coating is covered by a protective film 31. The protective film 31 is removed on a delaminating device 32 before connection to the frame material 20. Downstream of the delaminating device 32 in the direction of transport of the carrier web 30, the frame material 20 is laminated to the carrier web 30 on a laminating device 41, illustrated schematically as an arrow.

The punching and detachment roller 40 comprises at least one punching contour 401, in the exemplary embodiment illustrated two punching contours 401. However, the number and arrangement of the punching contours 401 is merely illustrative.

Using the punching contours 401, a peripheral contour cut for a window cutout 22 that cuts through the frame material 20 can in each case be made without cutting through the carrier web 30. The carrier web 30 thus serves for stabilization. To ensure that the frame material 20 is cut through completely, the punching contour 401 penetrates into the carrier web 30 but without cutting through the carrier web 30 in some embodiments. In other embodiments, the carrier web 30 remains undamaged as the frame material 20 is cut through. The punching and detachment roller 40 interacts with an anvil roller 43, wherein a cutting nip 423 is formed between the punching and detachment roller 40 and the anvil roller 43.

In the exemplary embodiment illustrated, a protective film 21 is provided on the frame material 20, wherein the carrier web 30 and the protective film 21 are arranged on opposite sides of the frame material 20. The protective film 21 is cut through together with the frame material 20, wherein in each case a punching chad 201, 211 is formed.

The punching and detachment roller 40 furthermore has a multiplicity of suction openings 402, each arranged within the punching contour 401.

The rotatable punching and detachment roller 40 is part of a detachment device, which further comprises a schematically illustrated vacuum device 42, wherein the vacuum device 42 can be connected fluidically to the suction opening 402.

The vacuum device 42 is configured to apply a suction force to the punching chads 201, 211 via the suction opening 402, in a region that follows the cutting nip 423 in the direction of rotation, as the punching and detachment roller 40 rotates in order to detach the punching chads 201, 211 from the carrier web 30 by use of the suction force and to transport the punching chads 201, 211 away from the material combination comprising the carrier web 30 and the frame material 20.

The detachment device illustrated further comprises a suction funnel 44 arranged at the circumference of the punching and detachment roller 40. The suction funnel 44 receives the punching chads 201, 202 from the punching and detachment roller 40 for onward transport.

Downstream of the detachment of the punching chads 201, 211 in the direction of transport of the frame material 20, provision is made in some embodiments for a delaminating device (not illustrated in FIG. 1), by means of which a residual grid of the protective film 21 that remains on the frame material 20 can be delaminated from the frame material 20.

In the exemplary embodiment illustrated, an embossing roller 45 for the application of an embossed line on the subsequently formed punching chad 201 is provided further upstream of the punching and detachment roller 40. The embossed line is introduced parallel to a leading edge of the subsequent punching chad 201. During or before the detachment of the punching chad 201, a forward region of the subsequent punching chad 201 can be bent around the embossed line. The embossed line thus serves as an aid in the detachment of the punching chad 201 from the carrier film 30. A suitable distance between the embossed line and a leading edge of the punching chad 201 can be chosen according to the application.

In the exemplary embodiment illustrated, the embossing roller 45 is provided upstream of the laminating device 41 in the direction of transport of the frame material 20. In other embodiments, the embossing roller 45 is arranged downstream of the laminating device 41.

In some embodiments, the punching and detachment roller 40 illustrated in FIG. 2 is configured as a vacuum roller comprising a multiplicity of suction openings 402 arranged in a manner distributed over the circumference, wherein a punching plate having the punching contour 401 can be secured on a circumference of the punching and detachment roller 40, or a plurality of punching plates, each having a punching contour 401, can be secured thereon.

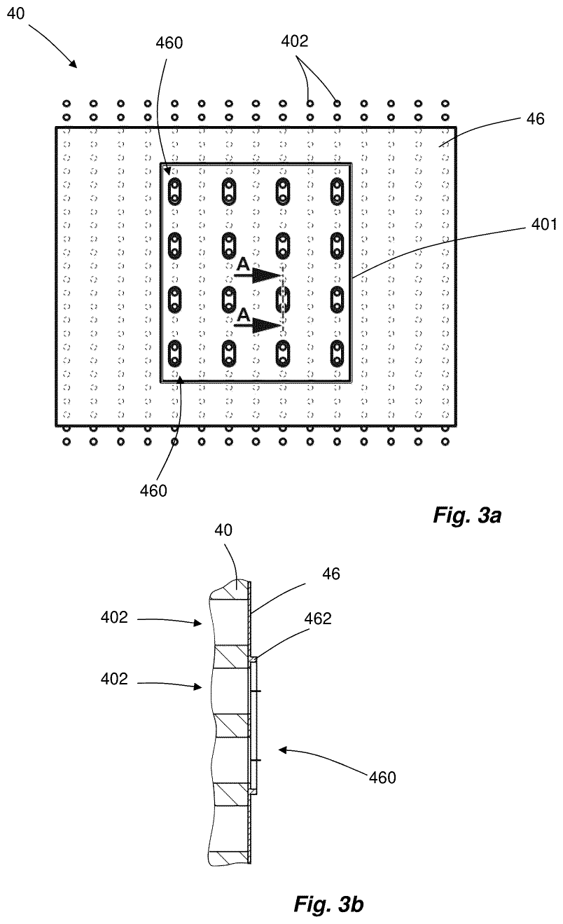

FIGS. 3a and 3b schematically show a developed plan view and a sectional view, respectively, of a segment of a punching and detachment roller 40 configured as a vacuum roller, and a punching plate 46. As illustrated schematically in FIG. 3a, in some embodiments the punching and detachment roller 40 configured as a vacuum roller has a multiplicity of suction openings 402 arranged in a manner distributed uniformly over the circumference. A punching plate 46 having the punching contour 401 is secured, e.g. by magnetic force, on the circumference of the punching and detachment roller 40 configured as a vacuum roller.

The suction openings 402 are very largely covered by the punching plate 46, as illustrated schematically in FIG. 3a. In order to be able to use the vacuum roller as a detachment roller, the punching plate 46 has, within the punching contour 402, a plurality of apertures 460 for one or more suction openings 402. In the exemplary embodiment illustrated, sixteen apertures 460 arranged in a matrix are provided. However, the number and arrangement are purely illustrative. In the exemplary embodiment illustrated, the apertures 460 are all of the same size and each expose two suction openings 402. In other embodiments, the apertures are of larger or smaller design.

As can best be seen in FIG. 3b, the apertures 460 in the exemplary embodiment illustrated are each delimited by a peripheral ridge 462 projecting from a surface of the punching plate 46. The ridge 462 delimits a region in which the suction force applied via the suction openings 402 acts on the punching chad 201 (not illustrated in FIG. 3a/3b). The ridge 462 promotes the formation of pockets on the punching chad 201. In other words, the punching chad 201 is bent within the aperture 460 in the direction of the vacuum roller for reliable detachment.

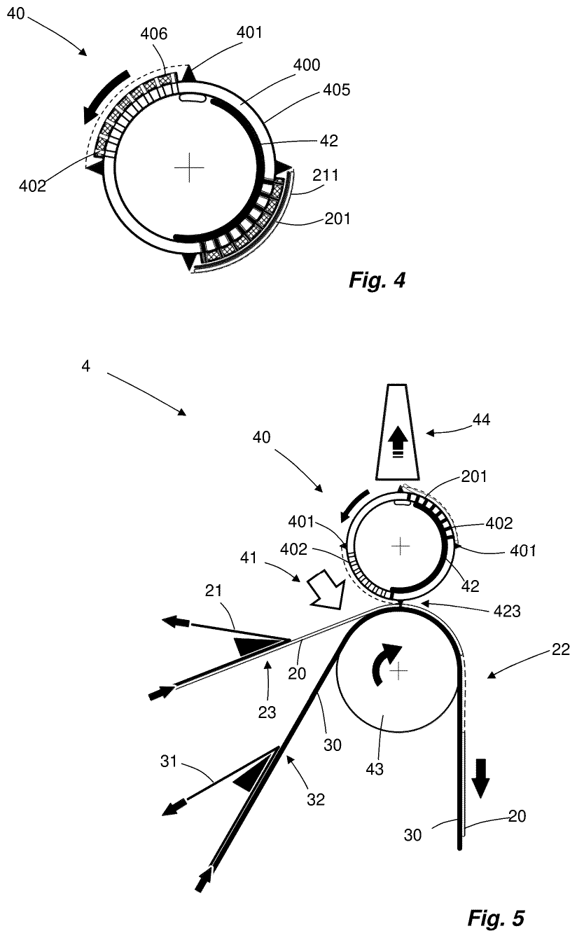

FIG. 4 shows schematically an alternative configuration of a punching and detachment roller 40 for use in the apparatus according to FIG. 2 and punching chads 201, 211 picked up using the punching and detachment roller 40.

In contrast to the configuration as a vacuum roller as per FIG. 3a/3b, the punching and detachment roller 40 illustrated in FIG. 4 comprises a rotating roller body 400 with a closed surface 405. The punching contour 401 is provided on the surface 405 of the roller body 400. An insert 406 for the suction opening 402 is provided within the punching contour 401 on the roller body 400.

FIG. 5 shows, in a schematized form, a second exemplary embodiment of an apparatus 4 for making the window cutouts 22 in the frame material 20. The apparatus 4 shown in FIG. 5 is similar to the apparatus 4 shown in FIG. 2, and corresponding reference signs are used for the same or similar components; see above for a detailed description. In the configuration shown in FIG. 5, in contrast to the configuration shown in FIG. 2, a delaminating device 23, by means of which a protective film 21 can be pulled off before the contour cuts are made in the frame material 20, is provided upstream of the punching and detachment roller 40 in the direction of transport of the frame material 20.

In the manner described above, contour cuts are made in the frame material 20 using the punching and detachment roller 40, with punching chads 201 being formed, and the punching chads 201 are transported away.

In the diagram, the delaminating device 23 is provided upstream of the laminating device 41 in the direction of transport. In other embodiments, the delaminating device 23 is provided downstream of the laminating device 41. In yet other embodiments, delamination of the protective film 21 takes place simultaneously with lamination of the carrier web 30.

In some embodiments, the apparatus 4 shown in FIG. 5 also comprises an embossing roller 45 (cf. FIG. 2), which is not illustrated in FIG. 5, in order to introduce an embossed line into the frame material to promote detachment of the punching chad 201.

The punching and detachment roller 40 for the apparatus shown in FIG. 5 can be configured as per FIG. 3a/3b or as per FIG. 4, for example, depending on the application.

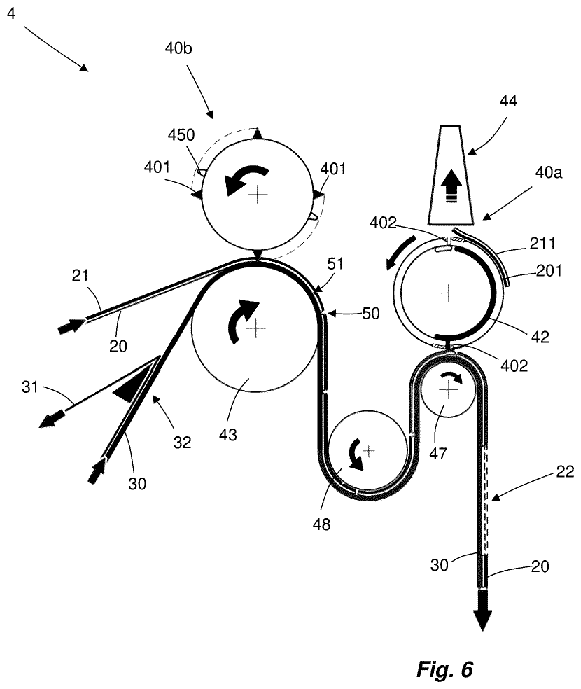

FIG. 6 shows, in a schematized form, a third exemplary embodiment of an apparatus 4 for making the window cutouts 22 in the frame material 20. Here, the frame material 20 is laminated with a carrier web 30. In the embodiment shown in FIG. 6, in contrast to the apparatuses 4 shown in FIGS. 2 and 5, a detachment roller 40a and a punching roller 40b separate therefrom and arranged upstream in the direction of transport are provided.

The punching roller 40b illustrated in FIG. 6 has a closed punching contour 401 for the contour cut 50 to be made. The punching roller 40b interacts in a known manner with an anvil roller 43. The punching roller 40b furthermore has an embossing edge 450 for the application of an embossed line 51 to the punching chad 201 produced parallel to a leading edge of the punching chad 201. The embossed line 51 serves to promote detachment of the punching chad 201 from the carrier web 30, which is carried out subsequently using the detachment roller 40a.

To detach the punching chads 201, a detachment device comprising the detachment roller 40a, a vacuum device 42 and a suction funnel 44 arranged at the circumference of the detachment roller 40a is provided.

At least one suction opening 402 that can be connected fluidically to the vacuum device 42 as the detachment roller 40a rotates is provided on the detachment roller 40a. A plurality of suction openings 402 arranged in alignment in a row in the axial direction of the detachment roller 40a is preferably provided. The detachment roller 40a interacts with a pressure roller 47.

Using the vacuum device 42, a suction force can be applied to the punching chad 201 via the suction opening 402 as the detachment roller 40a rotates in order, as illustrated schematically in FIG. 6, first of all to peel the punching chad 201 from the carrier web 30 at a leading end by use of the suction force and then to transport the punching chad 201 away from the carrier web 30 and the frame material 20 using the detachment roller 40a.

In the exemplary embodiment illustrated, a deflection roller 48 is provided between the punching roller 40b and the detachment roller 40a. In other embodiments, a deflection roller 48 is dispensed with, or a plurality of deflection rollers 48 is provided.

In the exemplary embodiment illustrated in FIG. 6, the frame material 20 is made available with a protective film 21, wherein the frame material 20 together with the protective film 21 is fed to the punching roller 40b and then to the detachment roller 40a. In this case, the protective film 21 is cut through together with the frame material 20, and therefore a punching chad 211 is likewise formed on the protective film 21, and this is transported away using the detachment roller 40a together with the punching chad 201 of the frame material 20.

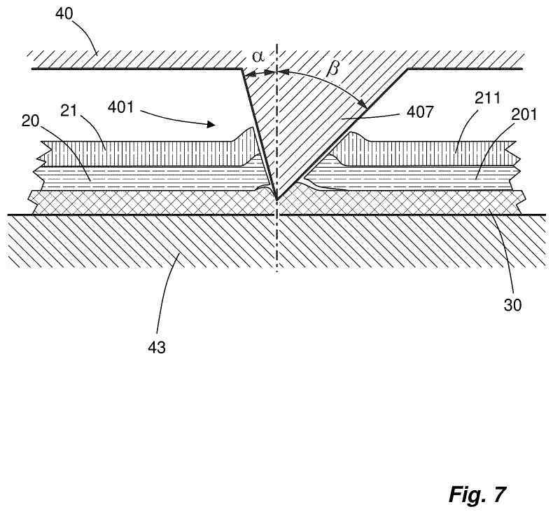

FIG. 7 shows schematically, in an enlarged detail view, a punching contour 401 of the punching and detachment roller 40 shown in one of FIGS. 2 to 4 or of the punching roller 40b shown in FIG. 6 as the frame material 20 together with the protective film 21 arranged on the carrier web 30 is cut through, forming the punching chads 201, 211.

The punching contour 401 illustrated in FIG. 7 has an asymmetrical cutter 407. In the exemplary embodiment illustrated, an angle β of the cutter 407 relative to a radial direction (illustrated by a dash-dotted line) of the punching and detachment roller 40 or of the punching roller 40b on an inner side facing the punching chad 201 is larger than an angle α on an opposite outer side. For example, the angle β on the inner side is about 30° to about 50°, e.g. 45°, and the angle α on the outer side is about 15°. However, the configuration is not limited to these values. Owing to the relatively large angle β on the outer side, a cut-through material is pushed to the side during the process of cutting through, and detachment of the punching chads 201, 211 is brought about in this way. A smaller or more acute angle α provided on the other side prevents the frame material 20 from also being detached from the carrier web 30 on the opposite side of the cutting contour 401.

1. An apparatus for making window cutouts in a frame material in web form for a membrane electrode unit, wherein a punching device and a detachment device are provided, wherein the frame material can be fed to the punching device as a material combination with a carrier web, wherein the punching device is configured to make in the frame material a contour cut that cuts through the frame material from a side of the frame material opposite to the carrier web, while forming a punching chad, without cutting through the carrier web, and wherein the detachment device is configured to separate the punching chad from the material combination, wherein the detachment device comprises a rotatable roller and a vacuum device, wherein a suction opening that can be connected fluidically to the vacuum device is provided on the roller, and wherein the vacuum device is configured to apply a suction force to the punching chad via the suction opening as the roller rotates in order to detach the punching chad from the carrier web by use of the suction force and to transport it away from the material combination using the roller.

2. The apparatus according to claim 1, wherein the roller is configured as a punching and detachment roller comprising the suction opening and a closed punching contour for the contour cut to be made, wherein the suction opening is arranged within the closed punching contour, wherein an embossing roller for applying an embossed line in the region of the punching chad is provided parallel to a leading edge of the punching chad, in particular upstream of the punching and detachment roller.

3. The apparatus according to claim 2, wherein the punching and detachment roller is configured as a vacuum roller comprising a multiplicity of suction openings arranged in a manner distributed over the circumference, wherein the apparatus comprises a punching plate, which has the punching contour and can be secured on a circumference of the punching and detachment roller, wherein the punching plate has, within the punching contour, an aperture for one or more suction openings, wherein, in particular, the aperture is delimited by a ridge projecting from a surface of the punching plate.

4. The apparatus according to claim 2, wherein the punching and detachment roller comprises a rotating roller body with a closed surface, wherein the punching contour is provided on the surface of the roller body, and wherein an insert for the suction opening is provided on the roller body within the punching contour, wherein, in particular, the insert has a ridge which surrounds the suction opening for the application of the suction force.

5. The apparatus according to claim 1, wherein the roller is configured as a detachment roller, and the punching device comprises a rotatable punching roller arranged upstream of the detachment roller in the direction of transport of the frame material, wherein the punching roller has a closed punching contour for the contour cut to be made, wherein, in particular, the punching roller has an embossing edge for the application of an embossed line on the punching chad parallel to a leading edge of the punching chad.

6. The apparatus according to claim 2, wherein the punching contour of the punching and detachment roller or the punching roller has an asymmetrical cutter, wherein, in particular, an angle of the cutter relative to a radial direction of the roller is larger on an inner side facing the punching chad than on an opposite outer side.

7. The apparatus according to claim 1, wherein the detachment device comprises a suction funnel arranged at the circumference of the roller.

8. The apparatus according to claim 1, wherein the frame material can be made available with a protective film, wherein a laminating device for connecting the carrier web to the frame material is provided, wherein the one laminating device is configured in order to connect the carrier web to the frame material on an opposite side from the protective film, and wherein the apparatus has a delaminating device, which is arranged upstream or downstream of the punching device and the detachment device and is configured to delaminate the protective film from the frame material.

9. A method for making window cutouts in a frame material in web form for a membrane electrode unit, wherein, at least in some section or sections, the frame material is processed as a material combination with a carrier web, wherein a contour cut that cuts through the frame material is made in the frame material from a side of the frame material opposite to the carrier web, while forming a punching chad, wherein the contour cut is made without cutting through the carrier web, and wherein the punching chad is separated from the material combination, wherein the punching chad is separated from the material combination using a rotatable roller having a suction opening, wherein a suction force is applied to the punching chad via the suction opening, with the result that the punching chad is detached from the carrier web by use of the suction force and transported away from the material combination using the roller.

10. The method according to claim 8, wherein the punching chad is transported away using the roller to a suction funnel arranged at the circumference of the roller.

11. The method according to claim 8, wherein the roller is configured as a punching and detachment roller, wherein the contour cut is made in the frame material using the punching and detachment roller, or in that a punching roller is provided upstream of the roller in the direction of transport of the frame material, wherein the contour cut is made in the frame material using the punching roller.

12. The method according to claim 8, wherein the frame material is made available with a protective film, wherein the carrier web is laminated to the frame material on a side facing away from the protective film, and wherein the protective film is delaminated from the frame material upstream or downstream of the roller.

13. Use of a rotatable roller in making a window cutout in a frame material in web form for a membrane electrode unit, wherein the frame material can be fed to the roller as a material combination with a carrier web, wherein a suction opening that can be connected fluidically to a vacuum device is provided on the roller, wherein, as the roller rotates, a suction force is applied via the suction opening to a punching chad arranged in the window cutout in order to detach the punching chad of the frame material from the carrier web by use of the suction force and to transport it away from the material combination using the roller.

14. The use according to claim 13, wherein the roller is configured as a punching and detachment roller comprising a closed punching contour and the suction opening, wherein the suction opening is arranged within the closed punching contour.

15. The use according to claim 14, wherein the punching and detachment roller is configured as a vacuum roller comprising a multiplicity of suction openings arranged in a manner distributed uniformly over the circumference, wherein a punching plate, which has the punching contour, can be secured on a circumference of the punching and detachment roller, wherein the punching plate has, within the punching contour, an aperture for one or more suction openings, wherein, in particular, the aperture is delimited by a ridge projecting from a surface of the punching plate.

16. The use according to claim 14, wherein the punching and detachment roller comprises a rotating roller body with a closed surface, wherein the punching contour is provided on the surface of the roller body, wherein an insert for the suction opening is provided on the roller body within the punching contour, wherein, in particular, the insert has a ridge, which surrounds the suction opening for the application of the suction force.
